(19) United States
(12) Patent Application Publication
(10) Pub. No.: US 2025/0070903 A1
(43) Pub. Date: Feb. 27, 2025

(54) METHODS AND SYSTEMS FOR EXPANDING LANGUAGE SET FOR WIRELESS EMERGENCY ALERTING

(71) Applicant: T-Mobile USA, Inc., Bellevue, WA (US)

(72) Inventors: Terri L. Brooks, Prosper, TX (US); Timothy N. Dunn, Issaquah, WA (US)

(21) Appl. No.: 18/456,280

(22) Filed: Aug. 25, 2023

(51) Int. Cl. H04H 20/59; G06F 40/126; G06F 40/58; H04W 4/90

(52) U.S. Cl. CPC H04H 20/59; G06F 40/126; G06F 40/58; H04W 4/90

(57) ABSTRACT

Methods and systems for expanding language set for wireless emergency alerting are described herein. According to an implementation, a computer system, e.g., an alert broadcast system (ABS), may receive an alert generated by an alerting authority. The computer system may determine a target area that the alert is to be broadcasted. Based on a penetration of speakers with first language other than English and Spanish, the computer system may determine a third language to broadcast the alert. In some examples, the computer system may include a link to the translation of the alert in the third language in the English and Spanish language alerts. In some other examples, the computer system may send a separate alert to the English and Spanish language alerts. The separate alert may include a link to a resource that allows the alert recipient to obtain a translation of the alert.

### BACKGROUND

Current wireless emergency alerting (WEA) system in U.S. uses only English and Spanish to broadcast WEA text messages, i.e., emergency alerts. Some jurisdictions have a high penetration of speakers with first languages other than English and Spanish. Many of these speakers are not proficient enough in English or Spanish to quickly comprehend and react to the emergency alerts. System capacity impacts from supporting additional languages in the same manner that English and Spanish are currently supported could be significant. There is a need to expand the current language set for WEA messages with less capacity impact.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example network scenario, in which methods for expanding language set for wireless emergency alerting is implemented, according to an example of the present disclosure.

FIG. 2 illustrates an example scenario, in which methods for expanding language set for wireless emergency alerting is implemented, according to an example of the present disclosure.

FIG. 3 illustrates another example scenario, in which methods for expanding language set for wireless emergency alerting is implemented, according to another example of the present disclosure.

FIG. 4 illustrate an example flowchart for expanding language set for wireless emergency alerting, according to an example of the present disclosure.

FIG. 5 illustrate another example flowchart for expanding language set for wireless emergency alerting, according to another example of the present disclosure.

FIG. 6 illustrates another example flowchart for expanding language set for wireless emergency alerting, according to another example of the present disclosure.

FIG. 7 illustrates an example computer server, in which methods for expanding language set for wireless emergency alerting, according to an example of the present disclosure.

### DETAILED DESCRIPTION

Techniques for expanding language set for wireless emergency alerting, are disclosed herein.

In implementations, a computer system may receive real-time alerts generated by various alert authorities. The real-time alert may include geographic information describing a target area throughout which the alert is to be disseminated. The computer system may obtain data indicative of a penetration of speakers with first language other than English and Spanish in the target area. In some examples, the data may be obtained from the national census data. Based on the penetration of speakers with first language other than English and Spanish in the target area, the computer system may determine that at least a third language to broadcast the alert may be beneficial.

In some examples, the computer system may generate the alert in English and Spanish and include a link to the translation of the alert in the third language in the English and Spanish language alerts.

In some other examples, the computer system may send a separate alert to the English and Spanish language alerts. The separate alert may include a full translation of the alert content in the third language.

Alternatively, the separate alert may include the link to the translation of the alert in the third language.

In yet another example, the computer system may send a separate alert to include one of more links to a resource that allows the alert recipient to obtain a translation of the alert in his/her needs.

In some examples, the English and Spanish language alert messages may be encoded using the global system for mobile communication-7 (GSM-7) encoding scheme. A separate alert may be encoded using a different encoding scheme such as, the universal character set-2 (UCS-2) encoding scheme.

In implementations, the computer system may determine one or more cells or sectors in a wireless communication network to broadcast the at least one alert message based at least in part on an overlapping coverage between the broadcasts and the geographic area targeted for the alert and transmit the alert in English, Spanish, a third language, and/or a link to translation of the alert in the third language to one or more access points associated with the one or more cells in a wireless communication network.

In implementations, the alert may be broadcasted to an area based on the cells or sectors chosen through the wireless communication network. The mobile devices located in the area may receive the broadcasted alert. Upon receiving the alert message, a mobile device may compare its geolocation with the target area. When the mobile device is inside the target area, the mobile device may display the alert message in a user interface according to a language setting of the device. For example, the mobile device may display the alert in Spanish if the default language of the device is set as Spanish. Additionally, the mobile device may display a separate alert message including a full translation of the alert in the third language, a link to the translation of the alert in the third language, or a link to a resource facilitating translation of the alert in the third language.

The present disclosure can provide flexibility in broadcasting the WEA alert in multiple languages. Depending on the penetration level of speakers with first language other than English and Spanish, the computer system (e.g., the Alert Broadcast System), may broadcast the WEA alert in English and Spanish with links to translation of third languages, or in a separate alert to include a full translation in the third language, or in a separate alert to include links to resources for translation. A multi-language support server and/or storage may be deployed to support the alert dissemination in multiple languages. Further, encoding of the alert sent in third languages may use different encoding scheme. The impact on the current system capacity may be minimized.

The techniques discussed herein may be implemented in a computer network using one or more of protocols including but are not limited to Ethernet, 3G, 4G, 4G/LTE, 5G, 6G, the further radio access technologies, or any combination thereof. In some examples, the network implementations may support architectures, non-standalone architectures, dual connectivity, carrier aggregation, etc. Example implementations are provided below with reference to the following figures.

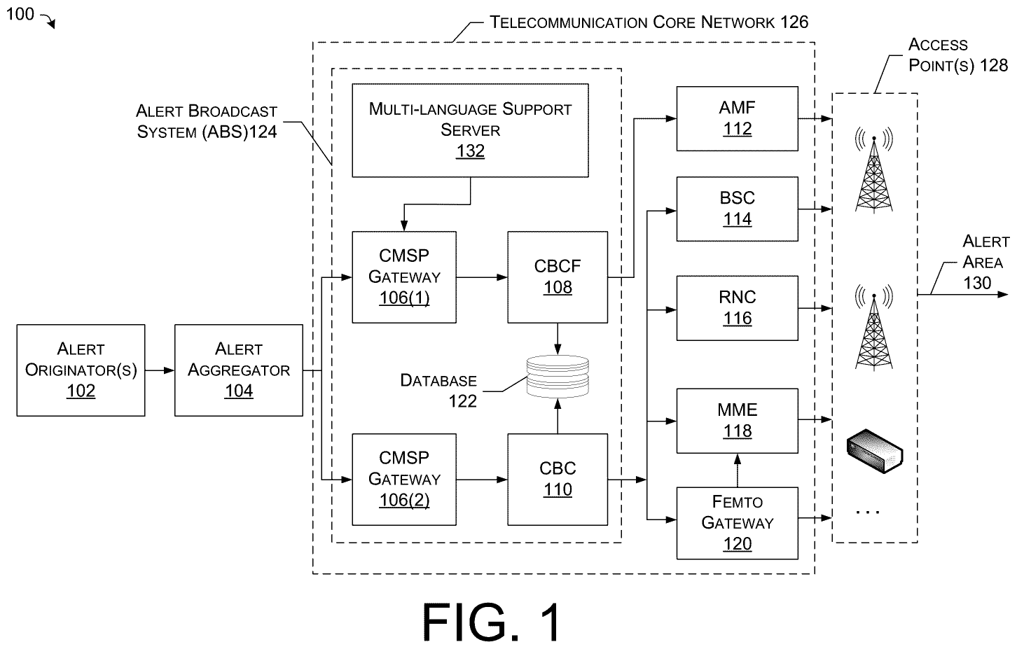

FIG. 1 illustrates an example network scenario 100, in which methods for expanding language set for wireless emergency alerting is implemented, according to an example of the present disclosure.

The network scenario 100, as illustrated in FIG. 1 may include an Alert Broadcast System (ABS) 124 configured to generate an alert message in one or more languages to be broadcasted to the public through various dissemination channels. A wireless emergency alert (WEA), as one type of the dissemination channels, may be sent to the mobile devices through a network of a wireless communication carrier, for example, a telecommunication core network 126, access point(s) 128, etc.

Alert originator(s) 102 may originate real-time alerts through computer devices and/or computer systems. The alert may include a description of the alert, for example, a severe weather alert, a missing child alert, a public safety alert, etc. In addition, the alert may also include an area that the alert is going to be broadcasted. Examples of the area may include but not limited to nation-wide, state-wide, a local county, a local city, a territorial area, a tribal area, etc. In general, a presidential alert, an imminent threat alert, and an Amber alert may trigger a WEA alert.

An alert aggregator 104 may receive the real-time alerts from the alert originator(s) 102, authenticate the alert originator(s), and make the alerts available to the dissemination channels. In some examples, the alert aggregator 104 may be an open platform implemented by an Integrated Public Alert & Warning System (IPAWS) of the Federal Emergency Management Agency (FEMA).

The alert broadcast system (ABS) 124 may include one or more commercial mobile service provider (CMSP) gateway, e.g., 106(1) and 106(2), a cell broadcast center function (CBCF) 108, a cell broadcast center (CBC) 110, and a database 122. The CMSP gateway 106(1) and 106(2) (hereinafter referred to as 106) may be configured to receive the real-time alert messages and allow authorized alert originators to send the alerts and/or warnings to mobile devices through IPAWS. The CBCF 108 may be configured to use the services of an access and mobility function (AMF) 112 and a network repository function (NRF) for alerts and/or warnings delivery. The CBC 110 may be configured to manage the transmission of alert/warning messages received from the CMSP gateway 106 and route the alert/warning messages to the target cells through a variety of network entities. In a GSM network, the CBC 110 may be connected to a base station controller (BSC) 114 to route the alert/warning messages to the target cells. In an UMTS network, the CBC 110 may be connected to a radio network controller (RNC) 116 to route the alert/warning messages to the target cells. In an LTE network, the CBC 110 may be connected to a mobility management entity (MME) 118 to route the alert/warning messages to the target cells. In a 5G network, the CBC 110 may be connected to the AMF 112 to route the alert/warning messages to the target cells. In some examples, the CBC 110 may be connected to a Femto gateway 120 to route the alert/warning messages to the target cells.

The database 122 may be configured to store the real-time and location-based alerts/warnings to be sent to the mobile devices.

Currently, English and Spanish are two languages supported for WEA alerts in the U.S. However, some jurisdictions have a high penetration of speakers with first languages other than English and Spanish. Many of those speakers may not be proficient enough in English or Spanish to quickly comprehend and react appropriately to the alerts. The present disclosure, thus, implements a scheme to provide additional language support for WEA alerts.

As shown in FIG. 1, a multi-language support server 132 may be connected to the ABS 124 to provide translation of the alert/warning messages to one or more languages other than English and Spanish. The multi-language support server 132 may be configured to provide a full and accurate translation of a real-time WEA alert message and further save the translation in a local storage and/or the database 122. The real-time WEA alert may then be sent to the mobile devices in English and Spanish with a link to the translation of the WEA alert in a third language. In some examples, the full translation of the WEA alert in the third language may be sent separately. In implementations, the multi-language support server 132 may be configured to provide a variety of resources for language translation. Rather than sending in full translation of the third language or with the link to the full translation, the ABS 124 may send the WEA alert in English and Spanish with links to multiple resources for language translation.

The WEA alerts/warnings may be sent to the mobile devices in an alert area 130 through access point(s) 128 of the telecommunication network. As discussed herein, the telecommunication core network 126 may be associated with a wireless service provider such as, T-Mobile, AT&T, Verizon Wireless, etc. The access point(s) 128 may include various types of base stations that are compatible with one or more radio access technologies (RATs), protocols, and/or standards, such as, 2G base stations and/or 3G NodeBs that are compatible with GSM and CDMA technologies, eNBs that are compatible with an Evolved UMTS Terrestrial Radio Access Network (E-UTRAN) technology, or gNBs that are compatible with new radio (NR) technology in 5G network.

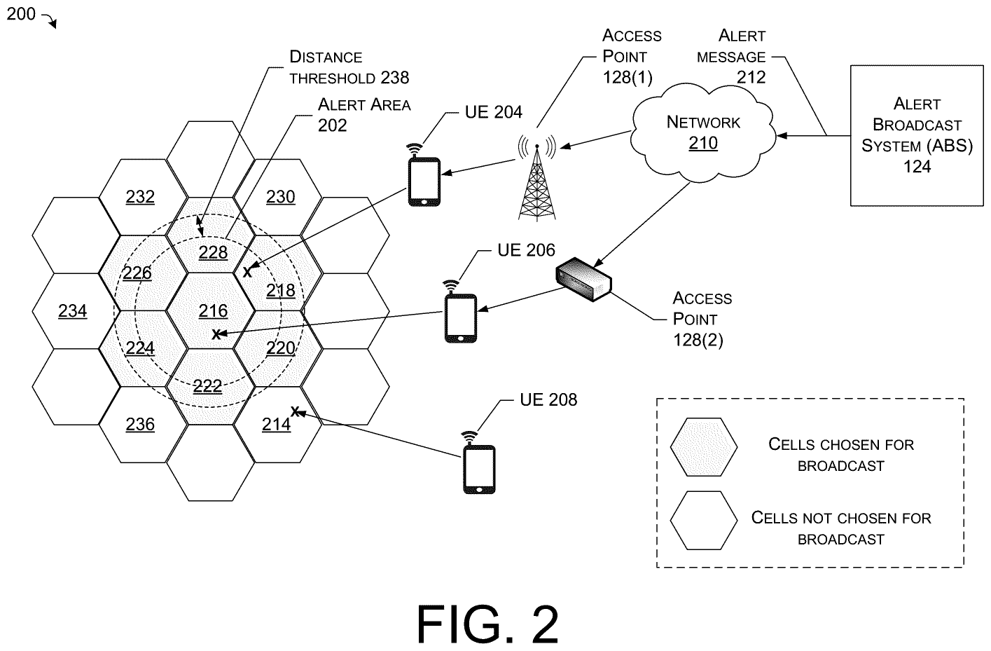

FIG. 2 illustrates an example scenario 200, in which methods for expanding language set for wireless emergency alerting is implemented, according to an example of the present disclosure.

As shown in FIG. 2, an alert message 212 targeted to an alert area 202 may be generated by the ABS 124 and sent to the network 210. The ABS 124, when generating the alert message 212, may choose one or more polygons or cells that are associated with the alert area 202. For example, eight cells including cells 216, 218, 220, 222, 224, 226, and 228, are associated with the alert area 202 and thus, are chosen for broadcasting the alert message 212. Therefore, the alert message 212 may be delivered to the mobile devices inside the eight cells.

The ABS 124 may further implement a distance threshold 238 such that the alert message 212 is not delivered to areas in a distance threshold outside the alert area 202. As shown in FIG. 2, the alert message 212 may be further delivered to mobile devices in five additional cells, 214, 230, 232, 234, and 236. However, the alert message 212 may not be delivered to cells beyond the eight cells (e.g., cells 216, 218, 220, 222, 224, 226, and 228) and the five additional cells (e.g., cells 214, 230, 232, 234, and 236). In implementations, the distance threshold 238 may be set as one-tenth of a mile (0.1 mile).

A mobile device located within those broadcasted cells may compare its geolocation with the alert area 202 to determine whether to display the alert message 212. For example, WEA 3.0 supports a device based geo-fencing (DBGF) application running on the mobile device that allows the mobile device to know if it is within a polygon/circle, or at least 0.1 mile outside, in order to display the alert, warning or notification to the user. The mobile device compatible with WEA 3.0, therefore, may be capable to determine whether to display the alert message 212 based on its geolocation. As shown in FIG. 2, user equipment (UE) 202 connected to access point 128(1) and located within cell 218 and UE 204 connected to access point 128(2) and located within cell 216 receive the alert message 212. The geolocations of the UE 204 and 206 are inside the alert area 202, and thus, the UE 204 and 206 display the alert message 212. UE 208 located within cell 214 also receives the alert message 212. As its geolocation is outside the alert area 202, UE 208 does not display the alert message 212.

In some examples, the mobile device may only support older versions of WEA (e.g., WEA 1.0 or WEA 2.0) or does not support WEA at all. The mobile device may not be capable of determining whether it is located within the area targeted by the alert. The mobile device may simply present the alert on the screen upon receiving the broadcast. In yet some other examples, the alert may be sent without a tightly defined alert area. The mobile device, regardless of whether WEA 3.0 compatible, may simply present the alert upon receiving the broadcast.

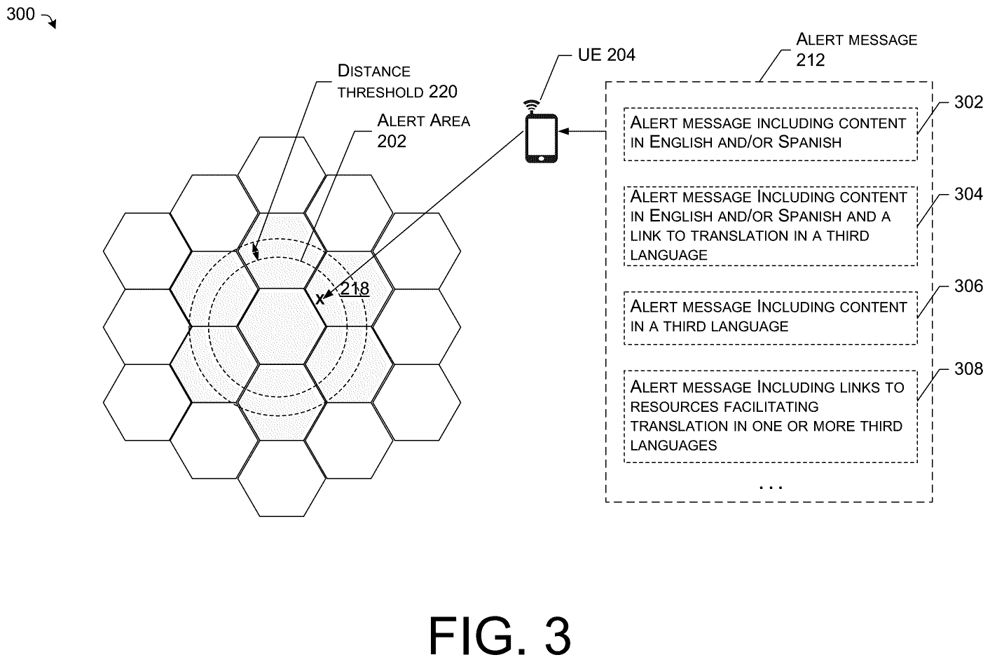

FIG. 3 illustrates another example scenario 300, in which methods for expanding language set for wireless emergency alerting is implemented, according to another example of the present disclosure.

The scenario 300 shown in FIG. 3 takes UE 204 as an example. The alert message 212 may be displayed in various formats based on the penetration of speakers with first language other than English and Spanish in the alert area 202. When the penetration of speakers with first language other than English and Spanish is low or lower than a threshold, the alert message 212 may be displayed on UE 204 as format 302 that includes content in English and/or Spanish.

When the penetration of speakers with first language other than English and Spanish is high or higher than the threshold, the alert message 212 may be displayed on UE 204 as format 304 that includes content in English and Spanish and a link to translation in a third languages. Alternatively, the alert message 212 may be displayed on UE 204 as format 306 that includes content in a third language. The content may be a full translation of the alert message 212 in the third language. In yet another example, the alert message 212 may be displayed on UE 204 as format 308 that includes links to resources facilitating translation in one or more third languages. The alert message 212 may be sent in format 308 separately to the original alert sent in English and/or Spanish, e.g., format 302. For example, the resources may include a website that allow a user to input the alert message 212 sent in English and/or Spanish to obtain a translation in a desired third language.

As discussed herein, current WEA alert system uses GSM-7 encoding scheme that packs the most commonly used letters and symbols in languages into 7 bits each for usage on GSM networks. As a fallback in many GSM networks, UCS-2, a character encoding standard, is also used to encode the message in a fixed length of 2 bytes. Supporting a third language broadcast in current WEA alert system may significantly impact the capacity. The present disclosure provides flexibility in broadcasting the WEA alert in multiple languages, for example, broadcasting the WEA alert to include links to translation of third languages other than English and Spanish, broadcasting the WEA alert to include links to resources for translation, or broadcasting the WEA alert in full translation of the third language. Therefore, impact on the current system capacity may be minimized.

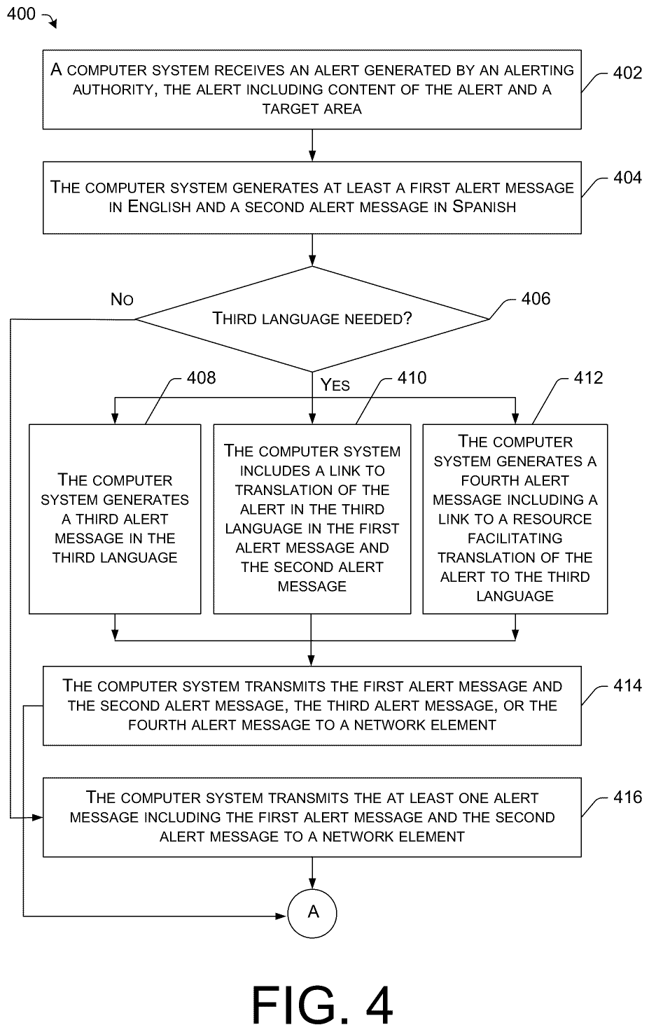

FIG. 4 illustrates an example flowchart 400 for expanding language set for wireless emergency alerting, according to an example of the present disclosure. The operations following the example flowchart 400 may be performed by the alert broadcast system (ABS) 124 and the multi-language support server 132 of FIG. 1.

At operation 402, a computer system may receive an alert generated by an alerting authority, the alert including content of the alert and a target area. The alerting authority may include a federal authority, a state authority, a local authority, etc. The target area may be represented as a polygon centered at a location where some event triggered the alert. In some examples, the target area may be represented by a jurisdiction area associated with the location where some event triggered the alert.

At operation 404, the computer system may generate a first alert message in English and a second alert message in Spanish. As discussed herein, currently alert system may be configured to disseminate the alert in English and Spanish.

At operation 406, the computer system may determine whether broadcasting the alert in a third language is needed. In implementations, the computer system may determine, based at least in part on a target area associated with the alert, a penetration rate of speakers with first language other than English and Spanish. The computer system may use the census data associated with the target area to determine the penetration rate. For example, some area in Brooklyn, New York city, may have a high penetration rate of people with first language being Italian. In implementations, a threshold of the penetration rate may be preset to determine whether broadcasting the alert in the third language is needed.

If it is determined that broadcasting the alert in a third language is not need, at operation 416, the computer system may transmit the first alert message and the second alert message to a network element. In implementations, when the penetration rate of speakers with first language other than English and Spanish is lower than the preset threshold, the computer system may determine that broadcasting the alert in a third language is not necessary and the alert is disseminated in English and Spanish.

If it is determined that broadcasting the alert in a third language is needed, at operation 408, the computer system may generate a third alert message in the third language. The third alert message may include a full and accurate translation of the alert content.

In some examples, the computer system may include a link to a translation of the alert in the third language in the first alert message and the second alert message, at operation 410, if it is determined that broadcasting the alert in a third language is needed. As discussed herein, the computer system may store the translation of the alert in the third language in a database. Instead of sending the full translation of the alert, the computer system may modify the first alert message in English and the second alert message in Spanish to include a link to the translated alert in the third language.

In yet another example, the computer system may generate a fourth alert message including a link to a resource facilitating translation of the alert to the third language, at operation 412, if it is determined that broadcasting the alert in a third language is needed. As discussed herein, the computer system may, alternatively, send a link to a resource that allows the user to input the alert content and get a translation in one or more third languages. For example, when data of an area shows Italian and Portuguese are two dominant language spoken by the residents, sending the alert in Italian or a link to the Italian translation may not be effective to warn all residents in the area. In another example, data of an area may show that the residents speak several dominant languages other than English and Spanish. The computer system may send the link to the resources to facilitate people to get the translation of the alert in the language they can understand.

At operation 414, the computer system may transmit the first alert message and the second alert message, the third alert message, or the fourth alert message to a network element. As discussed herein, the computer system may determine, based on the penetration rate of the speakers with first language other than English and Spanish in an area, the languages and formats to be used for broadcasting the alert.

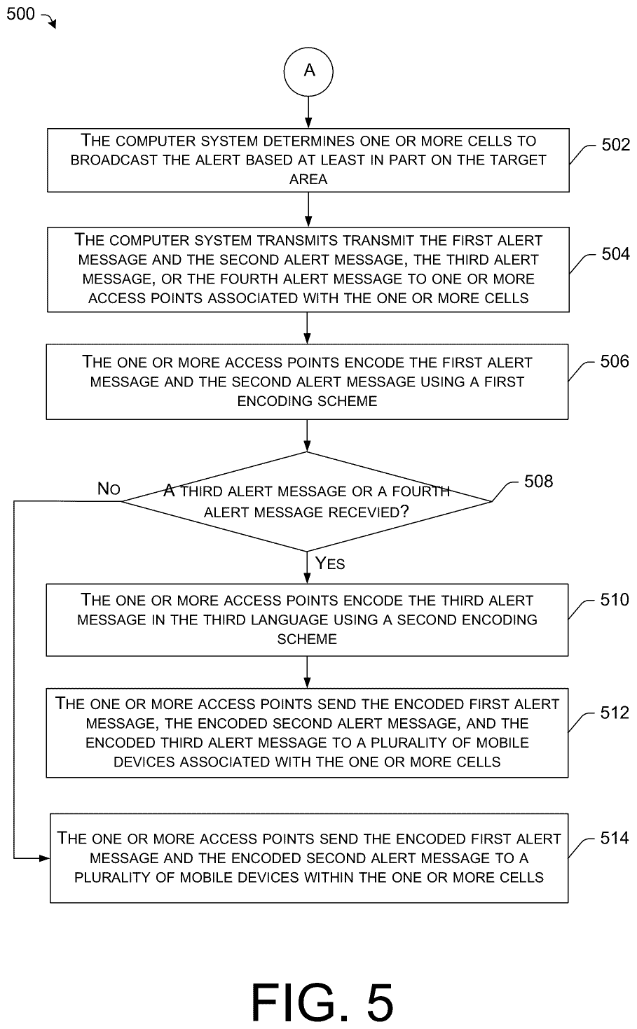

FIG. 5 illustrates another example flowchart 500 for expanding language set for wireless emergency alerting, according to another example of the present disclosure. The example flowchart 500 follows the example flowchart 400 and the operations described herein may be performed by various components of the alert broadcast system (ABS) 124 and one or more access point(s) 128 of FIG. 1.

At operation 502, the computer system may determine one or more cells to broadcast the alert based at least in part on the target area. As discussed herein, the target area may be represented as a polygon area centered that an event location, where the event triggered the alert. The computer system may determine one or more cells that are overlapped by the polygon area.

At operation 504, the computer system may transmit the first alert message and the second alert message, the third alert message, or the fourth alert message to one or more access points associated with the one or more cells. In some examples, the one or more access points may include base stations in a 2G/3G network, NodeBs in a 4G/5G networks, etc.

At operation 506, the one or more access points may encode the first alert message and the second alert message using a first encoding scheme. As discussed herein, the first alert message and the second alert message may be encoded using GSM-7 encoding scheme or UCS-2 encoding scheme.

At operation 508, the one or more access points may determine whether the third alert message or the fourth alert message is received. As discussed herein, in addition to disseminating the alert in English and Spanish, the computer system may also generate a third alert message with the alert fully translated in a third language, or a fourth alert message including a link to resources that allow the alert recipient to obtain the translation of the alert in various third languages.

If it is determined that the third alert message or the fourth alert message is not received, at operation 510, the one or more access points may send the encoded first alert message and the encoded second alert message to a plurality of mobile devices associated with the one or more cells.

At operation 514, the one or more access points may send the encoded first alert message and the encoded second alert message to a plurality of mobile devices associated with the one or more cells.

If it is determined that the third alert message or the fourth alert message is received, at operation 510, the one or more access points may encode the third alert message or the fourth alert message using a second encoding scheme. In some examples, the third alert message or the fourth alert message may be encoded using the second encoding scheme different from the first encoding scheme.

At operation 512, the one or more access points may send the first encoded alert message, the second encoded alert message, the encoded third alert message or the fourth alert message to a plurality of mobile devices associated with the one or more cells.

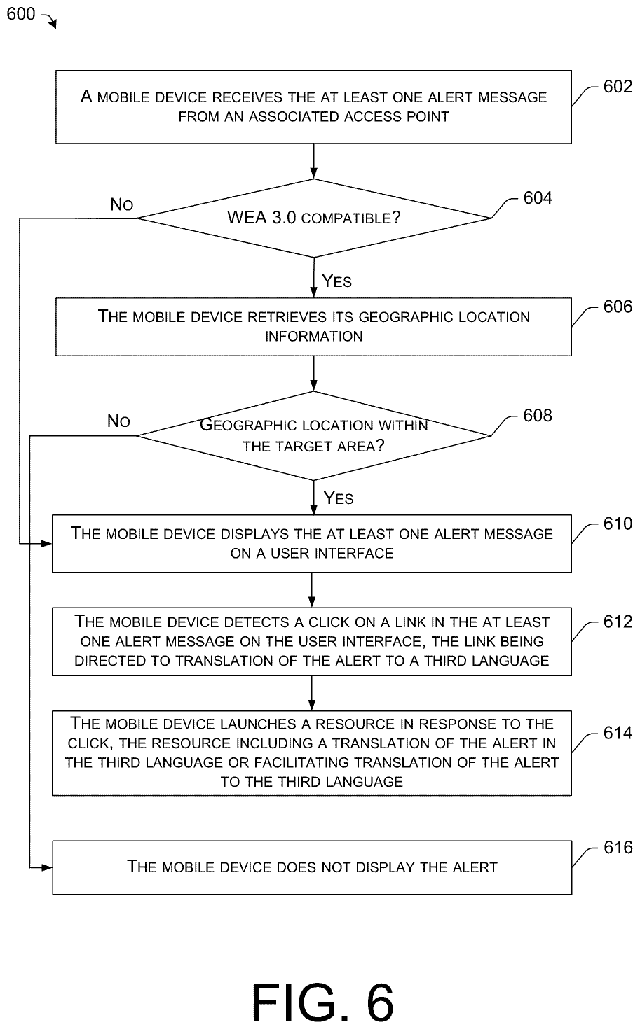

FIG. 6 illustrates yet another example flowchart 600 for expanding language set for wireless emergency alerting, according to another example of the present disclosure. The operations following the example flowchart 600 may be performed by a mobile device or a user equipment (UE 204, 206, or 208) of FIG. 2.

At operation 602, a mobile device may receive at least one alert message from an associated access point. The current WEA system may by default send the alert in at least one of English or Spanish. The present disclosure may deploy a separate server to facilitate disseminating the alert in one or more third languages.

At operation 604, the mobile device may determine whether the mobile device is compatible with WEA 3.0. If the mobile device is not compatible with WEA 3.0, at operation 610, the mobile device may display the at least one alert message on a user interface.

If the mobile device is compatible with WEA 3.0, at operation 606, the mobile device may retrieve its geographic location information. In implementations, the mobile device may utilize the global positioning system (GPS) to obtain the geographic location information.

At operation 608, the mobile device may determine whether the geographic location is within the target area. The mobile device may compare its geographic location with the target area and determine whether the mobile phone locates inside the target area.

If it is determined that the geographic location is not within the target area, at operation 616, the mobile device does not display the at least one alert message.

If it is determined that the geographic location is within the target area, at operation 610, the mobile device may display the at least one alert message on a user interface. In implementations, the mobile device may determine a language setting at the phone and display the alert message according to the language setting. For example, the mobile device may display the first alert message in English if the default language setting is English.

At operation 612, the mobile device may detect a click on a link in the at least one alert message on the user interface, the link being directed to translation of the alert to a third language. In some examples, the displayed alert message may be in English or Spanish and include a link to a full translation of the alert in a third language, or a link to a translation resources that allow the user to obtain the translation of the alert in the third language.

At operation 614, the mobile device may launch a resource in response to the click, the resource including a translation of the alert in the third language or facilitating translation of the alert to the third language.

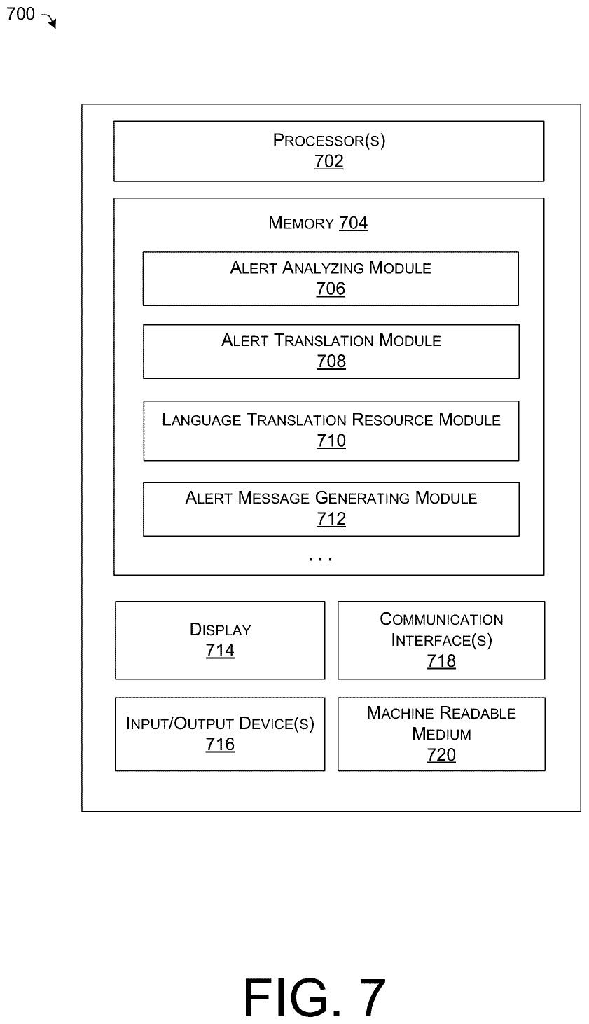

FIG. 7 illustrates an example computer server 700, in which methods for expanding language set for wireless emergency alerting, according to an example of the present disclosure. The example computer server 700 may correspond to the multi-language support server 132 of the alert broadcast system (ABS) 124, as illustrated in FIG. 1.

As illustrated in FIG. 7, a computer server 700 may comprise processor(s) 702, a memory 704 storing an alert analyzing module 706, an alert translation module 708, a language translation resource module 710, and an alert message generating module 712, a display 714, input/output device(s) 716, communication interface(s) 718, and/or a machine readable medium 720.

In various examples, the processor(s) 702 can be a central processing unit (CPU), a graphics processing unit (GPU), or both CPU and GPU, or any other type of processing unit. Each of the one or more processor(s) 702 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 702 may also be responsible for executing all computer applications stored in memory 704, which can be associated with common types of volatile (RAM) and/or nonvolatile (ROM) memory.

In various examples, the memory 704 can include system memory, which may be volatile (such as RAM), non-volatile (such as ROM, flash memory, etc.) or some combination of the two. The memory 704 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computer server 700. Any such non-transitory computer-readable media may be part of the computer server 700.

The alert analyzing module 706 may be configured to analyze the real-time alerts sent by various alert originators. The alert analyzing module 706 may determine the authorities of the various alert originators and the target areas associated with the real-time alerts. Based at least in part on the analysis, the alert analyzing module 706 may determine at least one dissemination channel for each received alert. For example, an Amber alert generated by a federal authority may be disseminated through the WEA system and the local television networks to a target area. A national security emergency alert generated by the federal authority may be disseminated through all radio and television networks of the nation. An alert related to the Internet or high-tech field generated by a local authority may be disseminated through web sites, mobile apps, etc.

The alert translation module 708 may be configured to provide the translation of the alert in English, Spanish, and at least one third language. By way of example and without limitation, the at least one third language may include Italian, French, Chinese, Vietnamese, Japanese, Germany, Portuguese, Arabic, etc.

The language translation resource module 710 may be configured to obtain and store a variety of language translation resources. An example of the language translation resources may be a website that allows the user to input the content to be translated to one or more languages other than English and Spanish. Another example of the language translation resources may be a link for the user to download a mobile app for language translation, in which, the mobile app may facilitate the translation via text input, audio input, image/video input auto-detection of copies context from another resource, etc.

The alert message generating module 712 may be configured to generate the alert messages for the real-time alert in English, Spanish, and at least one third language. The alert messages may include a location information that indicates an area the alert is targeted at. In some examples, the alert messages in English and Spanish may be a full translation of the alert content. In other examples, the alert messages in English and Spanish may further include a link to a full translation of the alert in a third language. In yet other examples, the alert message in the third language may be a full translation of the alert content, a link to the full translation, or a link to a translation resource

The communication interface(s) 718 can include transceivers, modems, interfaces, antennas, and/or other components that perform or assist in exchanging radio frequency (RF) communications with base stations of the telecommunication network, a Wi-Fi access point, and/or otherwise implement connections with one or more networks. The communication interface(s) 718 may be compatible with multiple radio access technologies, such as 2G/3G radio access technologies, 4G/LTE radio access technologies, 5G radio access technologies, and any future radio access technologies.

Display 714 can be a liquid crystal display or any other type of display commonly used in the computer server 700. For example, display 714 may be a touch-sensitive display screen and can then also act as an input device or keypad, such as for providing a soft-key keyboard, navigation buttons, or any other type of input. Input/output device(s) 716 can include any sort of output devices known in the art, such as display 714, speakers, a vibrating mechanism, and/or a tactile feedback mechanism. Input/output device(s) 716 can also include ports for one or more peripheral devices, such as headphones, peripheral speakers, and/or a peripheral display. Input/output device(s) 716 can include any sort of input devices known in the art. For example, input/output device(s) 716 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 720 can store one or more sets of instructions, such as software or firmware, that embodies any one or more of the methodologies or functions described herein. The instructions can also reside, completely or at least partially, within the memory 704, processor(s) 702, and/or communication interface(s) 718 during execution thereof by the computer server 700. The memory 704 and the processor(s) 702 also can constitute machine readable media 720.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, are not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system for expanding a language set for wireless emergency alerting, the system comprising:
one or more processors;
a non-transitory computer-readable memory storing computer-executable instructions that, when executed by the one or more processors, cause the system to:
receive an alert generated by an alerting authority, the alert including content of the alert and a target area;
determine at least one language to broadcast the alert based at least in part on languages used by people in the target area;
generate at least one alert message corresponding to the content of the alert in the at least one language; and
transmit the at least one alert message to a network element, causing the network element to broadcast the at least one alert message to a plurality of mobile devices associated with the target area.

2. The system of claim 1, wherein the at least one language includes English and Spanish, and the at least one alert message includes at least a first alert message in English and a second alert message in Spanish.

3. The system of claim 2, wherein the computer-executable instructions that, when executed by the one or more processors, cause the system further to:
determine a penetration of people speaking a third language in the target area; and
determine the third language to broadcast the alert based on the penetration.

4. The system of claim 3, wherein the computer-executable instructions that, when executed by the one or more processors, cause the system further to:
include a link to translation the content of the alert to the third language in the first alert message and the second alert message.

5. The system of claim 3, wherein the computer-executable instructions that, when executed by the one or more processors, cause the system further to:
generate a third alert message including a link to translation the content of the alert to the third language.

6. The system of claim 3, wherein the computer-executable instructions that, when executed by the one or more processors, cause the system further to:
generate a third alert message corresponding to the content of the alert in the third language.

7. The system of claim 6, wherein the third alert message is encoded using a coding scheme different from the first alert message and the second alert message.

8. The system of claim 7, wherein the third alert message is encoded using universal character set-2 (UCS-2), and the first alert message and the second alert message are encoded using global system for mobile communication-7 (GSM-7).

9. The system of claim 1, wherein the network element is further caused to:
determine one or more cells to broadcast the at least one alert message based at least in part on the target area; and
transmit the at least one alert message to one or more access points associated with the one or more cells, respectively, causing the one or more access points to send the at least one alert message to the plurality of mobile devices.

10. A computer implemented method, comprising:
receiving an alert generated by an alerting authority, the alert including content of the alert and an area that the alert is targeted at;
determining at least one language to broadcast the alert based at least in part on languages used by people in the area;
generating at least one alert message corresponding to the content of the alert in the at least one language; and
transmitting the at least one alert message to a network element, causing the network element to broadcast the at least one alert message to a plurality of mobile devices associated with the area.

11. The computer implemented method of claim 10, wherein the at least one language includes English and Spanish, and the at least one alert message includes at least a first alert message in English and a second alert message in Spanish.

12. The computer implemented method of claim 11, further comprising:
determining a penetration of people speaking a third language in the target area; and
determining the third language to broadcast the alert based on the penetration.

13. The computer implemented method of claim 12, further comprising:
including a link to translation the content of the alert to the third language in the first alert message and the second alert message.

14. The computer implemented method of claim 12, further comprising:
generating a third alert message including a link to translation the content of the alert to the third language.

15. The computer implemented method of claim 12, further comprising:
generating a third alert message corresponding to the content of the alert in the third language.

16. The computer implemented method of claim 15, wherein the third alert message is encoded using a coding scheme different from the first alert message and the second alert message.

17. The computer implemented method of claim 16, wherein the third alert message is encoded using universal character set-2 (UCS-2), and the first alert message and the second alert message are encoded using global system for mobile communication-7 (GSM-7).

18. The computer implemented method of claim 10, wherein the network element is further caused to perform operations including:
determining one or more cells to broadcast the at least one alert message based at least in part on the target area; and
transmitting the at least one alert message to one or more access points associated with the one or more cells, respectively, causing the one or more access points to send the at least one alert message to the plurality of mobile devices.

19. One or more non-transitory computer-readable storage media storing computer-readable instructions, that when executed by one or more processors, cause the one or more processors to perform operations including:
receiving an alert generated by an alerting authority, the alert including content of the alert and an area that the alert is targeted at;
determining at least one language to broadcast the alert based at least in part on languages used by people in the area;
generating at least one alert message corresponding to the content of the alert in the at least one language; and
transmitting the at least one alert message to a network element, causing the network element to broadcast the at least one alert message to a plurality of mobile devices associated with the area.

20. The one or more non-transitory computer-readable storage media of claim 19, wherein one or more processors are caused to perform operations further including:
determining a penetration of people speaking a third language in the target area;
determining the third language to broadcast the alert based on the penetration; and
broadcasting the alert in the third language including one of:
including a link to translation the content of the alert to the third language in a first alert message and a second alert message, or
generating a third alert message including the link to translation the content of the alert to the third language.
